(19) United States
(12) Patent Application Publication
(10) Pub. No.: US 2011/0005623 A1
(43) Pub. Date: Jan. 13, 2011

(54) Hydraulic Valve Device

(76) Inventor: Winfried Rüb, Waldshut-Tiengen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/735,581

(22) PCT Filed: Dec. 18, 2008
(86) PCT No.: PCT/EP2008/011167

§ 371 Date: Sep. 24, 2010

(30) Foreign Application Priority Data
Jan. 31, 2008 (DE) 10 2008 006 879.9

(51) Int. Cl. F16K 11/00

(52) U.S. Cl. 137/597

(57) ABSTRACT

The invention relates to a hydraulic valve device having a fluid port arrangement (10) with various ports which runs at least partially in the valve housing (14), and having a movable control device (18) for at least partially activating ports of the fluid port arrangement (10), wherein the control device (18) can be acted on at two opposite control sides with a control pressure (X_{A}, X_{B}) of an assignable activation unit (46). A valve device which is of narrow construction and which is functionally reliable is created in that a media-conducting duct (66), the guide path of which runs at least partially as an open duct channel which can be closed off by a cover part or by other housing parts of the multi-part valve housing (14), serves to conduct the control pressure (X_{B}) from the activation unit (46) to the assignable control side of the control device (18).

The invention relates to a hydraulic valve device with a fluid port arrangement which runs at least partially in the valve housing, containing ports such as
a pressure supply port P for making available a working pressure,
a return port R,
a section load sensing port LS,
two control ports P′_{A} and P′_{B}, and
two useful ports A, B for making available a useful port pressure, and with a movable control device for at least partially activating the ports of the fluid port arrangement, and the control device can be pressurized with a control pressure X_{A}, X_{B} of an assignable activation unit on two opposite control sides.

EP 1 370 773 B1 discloses a directional control valve for controlling the pressure and flow of hydraulic oil to and from useful ports of at least one consumer, in which the pressure and flow can be controlled by means of a sliding plunger as the control device which can be moved in a spool bore and which can be activated by at least one drive, and by means of ring channels which are dynamically connected to it as part of the fluid port arrangement, at the center point of symmetry on one axis of symmetry there being a tank port ring channel R and other ring channels being symmetrically located on both sides and being likewise components of the fluid port arrangement of the directional control valve. The sliding plunger as a component of the known control device is activated by an activation unit which stipulates the respective control pressure on the opposite control sides of the sliding plunger. The activation unit includes a differential cylinder which is located on one side of the actual valve housing, which induces activation for both stroke directions of the optionally also two-part sliding plunger, and which constitutes a separate component.

WO 2006/005496 A1 discloses a generic valve device, in particular in the form of a valve arrangement of a lifting mechanism. The known solution is used to activate a double-acting lifting mechanism or the attachment device of an agricultural vehicle with a continuously adjustable directional control valve which forms a metering throttle and to which an individual pressure compensator is assigned, via which a volumetric flow of hydraulic fluid flows to a working port A, B, the hydraulic fluid which flows back via another working port A, B flowing out via a directional control valve to a low pressure port or tank port T and with a pressure limitation valve which is located in a working line between the directional control valve and the working port A, B.

The pressure limitation valve is made to be preferably proportionally adjustable so that the pressure in the working line can be limited to different maximum values depending on the different operating states. To trigger the control device in the form of the sliding plunger of the indicated directional control valve, a control or pilot valve is used whose fluid-carrying output ports are connected to two control lines which are each routed to the face-side control spaces of the directional control valve. Here one control line which leads to the control chamber side of the directional control valve, which side is farther away, is designed, coming from the control or pilot valve, as a long connecting bore which is very thin in cross section, for which suitable drilling tools must be made available. A solution comparable thereto is also shown in DE 603 04 663 T2.

Based on this prior art, the object of the invention is to further improve the known valve devices such that a solution which is otherwise reliable and which can be produced economically is attained in a space-saving manner. This object is achieved by a valve device having the features of claim 1 in its entirety.

In that, as specified in the characterizing part of claim 1, for relaying the control pressure from the activation unit to the assignable control side of the control device, a media-carrying channel is used whose guide path runs at least partially as an open channel guide which can be closed off by the cover part or other housing parts of the multi-part valve housing as a shut-off part, a valve solution is devised in which the activation unit, preferably using the aforementioned control or pilot valves, can act directly on the control device, preferably in the form of at least one control piston or valve piston, without an additional actuating piston in the form of a differential cylinder or the like being necessary for this purpose. By omitting a separate actuating piston, in addition to production costs, the otherwise necessary installation space can also be saved.

Based on the configuration according to the invention, the media-carrying channel with an open channel guide which can be economically produced, for example, by means of a conventional cutting tool, replaces the long and thin connecting bore for producing the pressure connection between the control side of the control device and the indicated activation unit, so that production costs can be reduced and otherwise the cover part or other housing part which covers the open channel guide—even at high fluid pressures—can otherwise be made very thin-walled in a space-saving manner, so that especially valve solutions with a very narrow structure can be achieved in a width as cannot be made available by the prior art otherwise.

In mobile directional control valves, as in the present case with electrical activation, the assignable activating electronics are more and more often integrated into the valve housing for considerations of feasibility and space-savings. For pilot-controlled valves, as in this case, an activation pressure is used accordingly for moving the valve piston or sliding plunger. To the extent activation units located on both sides are used, the object is a compact and cost-favorable arrangement of the activation electronics for the two activating or pilot valves. These requirements are taken into account with the solution according to the invention, neither electrical nor hydraulic control lines need be installed outside on the valve housing; this is likewise shown in the prior art. The valve device solution according to the invention is preferably used in so-called compact machines, preferably within the framework of so-called exhaust gas aftertreatment and in cooling apparatus, the current exhaust gas guidelines in the major industrialized countries for this purpose requiring an increasingly higher construction effort so that for other components such as the indicated hydraulic solution, less and less installation space remains. The mobile directional control valves therefore need be designed to be especially narrow; this is achieved with the hydraulic valve device according to the invention.

Other advantageous embodiments are the subject matter of the dependent claims.

The hydraulic valve device according to the invention is detailed below using one exemplary embodiment as shown in the drawings. The figures are schematic and not to scale.

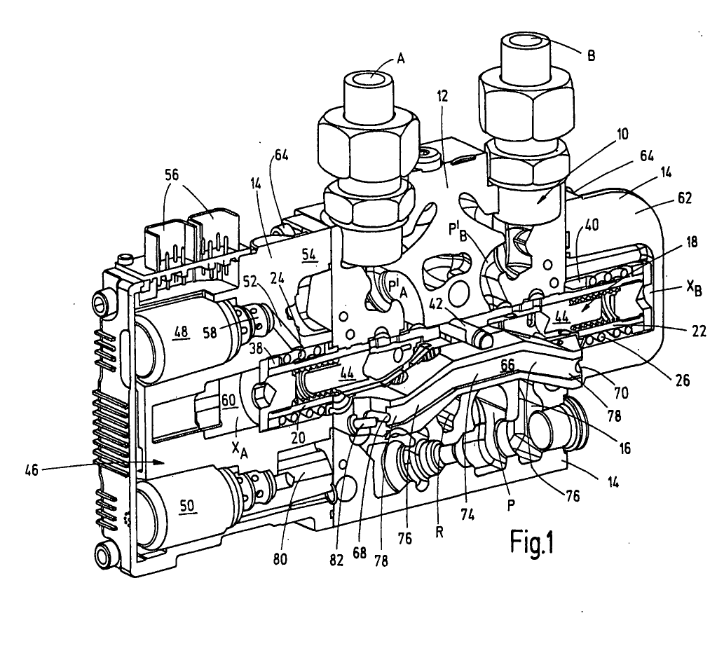

FIG. 1 shows a longitudinal section through the entire valve device in a perspective,

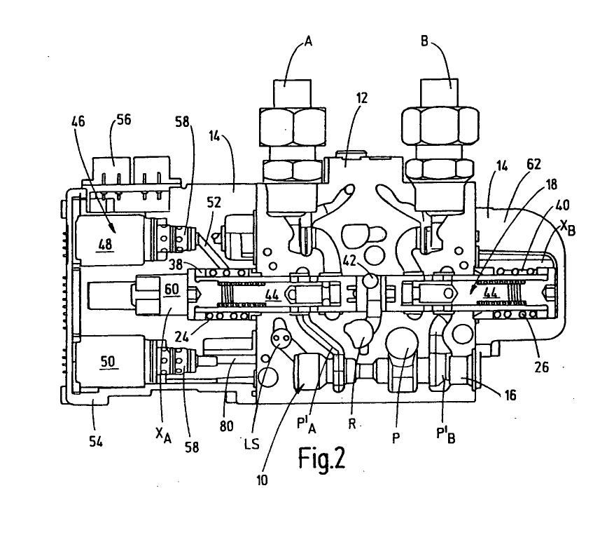

FIG. 2 shows a front view of the valve device as shown in FIG. 1, but without fluid guidance in the form of a media channel, and

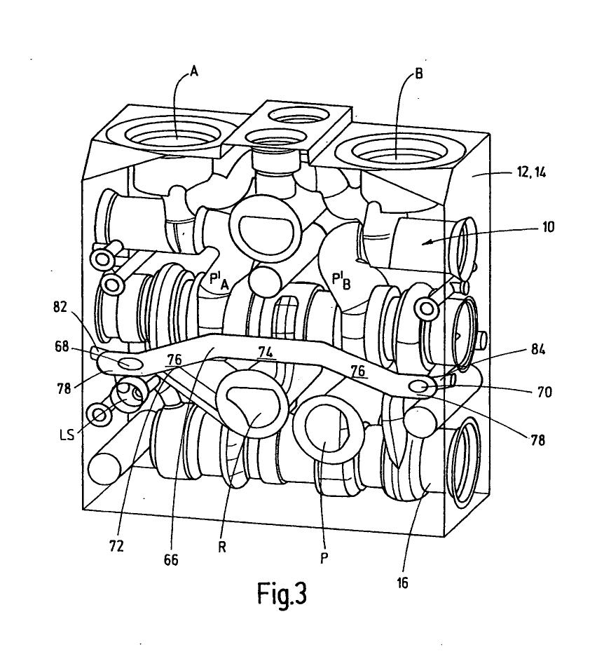

FIG. 3 shows an extract relating to the valve block as shown in FIGS. 1 and 2 with the fluid-guiding line parts, including fluid guidance in the form of the media channel as shown in FIG. 1.

The figures show a fluid port arrangement which is designated as a whole as 10. This fluid port arrangement 10 has pressure supply port P for making available a working or pump pressure, a return port R, a section load sensing port LS, two control ports P′_{A} and P′_{B}, and two useful ports A, B. The indicated fluid ports LS, P′_{A}, RT and P_{B}′, A and B are accommodated in a control housing 12 as part of the valve housing 14. Viewed in the direction of looking at the figures, the lower end of the control housing 12 has a common ring channel arrangement 16 into which if necessary a pressure compensator, which is not detailed, can be inserted and which then is connected upstream of the indicated fluid port arrangement 10 in the fluid flow direction and can also activate the latter. With this upstream pressure compensator, for example, the function of so-called quantitative cut-off by LS pressure limitation would be possible, this quantitative cut-off, for example, making sense when a steering cylinder, which is not detailed, connected to the useful ports A, B is at a stop, and to prevent overloads the inflow amount would be cut off This valve device, however, manages in terms of its basic function without a respective pressure compensator connected upstream.

Furthermore, the hydraulic valve device according to the invention is equipped with a control device which is designated as a whole as 18. The indicated control device 18 is equipped with two spool valves 20, 22 which can be moved horizontally viewed in the direction of looking at FIG. 1 and which are shown in their undeflected, centered middle or neutral position. This neutral position of the respective spool valve 20, 22 is supported by two spring storages which are made as compression springs 24, 26 and which are integrated in a respectively assignable spring space 38, 40 within the illustrated housing arrangement. The illustrated spool valve arrangement with two spool valves 20, 22, depending on the application of the directional control valve, can also be made as a one-piece and therefore single-piston control arrangement (not shown). In this case, however, preferably a dual spool valve arrangement is chosen, and the respective spool valves 20, 22 can be supported on a journal-shaped middle stop 42; otherwise, the mechanical structure of the respective spool valve 20, 22 with an internally guided, spring-supported inner piston 44 is known, so that it will not be further detailed here.

To activate the control device 18 an activation unit designated as a whole as 46 is used, and its essential components are two conventional control or pilot valves 48, 50 which are therefore not further detailed. On the output side the two pilot valves 48, 50 deliver two control pressures X_{A} and X_{B} which act in opposite directions, which prevail in the respective assignable spring space 38 and 40, and which here influence the two opposite control sides of the control device 18 with the two spool valves 20, 22. For penetration of the control pressure X_{A} from the output side of the pilot valve 48 to the assigned control side in the form of the first spring space 38, an oblique bore 52 in the activation housing 54 is used; it is a component of the valve housing 14, and the power or activation electronics 56 is contained at least partially in it, FIGS. 1 and 2 showing only the two plug parts illustrated above as an electrical terminal connection. The two control or pilot valves 48, 50, as shown in FIGS. 1 and 2, are shown in a vertical arrangement on top of one another, and their actuatable valve pistons 58 have adjustment directions parallel to the respective longitudinal displacement axis of the two spool valves 20, 22.

Otherwise, the spool valve 22, which is the left one viewed in the direction of looking at FIGS. 1 and 2, engages a center middle recess 60 between the two valves 48, 50 in the activation housing 54. The activation housing 54 is connected as a flange port design to the left face side of the control housing 12 in order to implement a valve solution with a flat structure. On the opposite face side the right spool valve 22 discharges into a port housing 62 which in turn, for implementing a valve with a narrow structure, in width has only very small dimensions and in this case is connected to the opposite face side of the control housing 12 likewise as a flange port design without a projection. The respective flange connection is implemented by way of conventional screw connection designs 64, for the sake of simplicity not all attachment screws being shown. The port housing 62 moreover ensures a simpler mounting structure and allows dismounting of the overall valve arrangement for maintenance purposes. The control housing 12, the activation housing 54, and the port housing 62 together form the multi-part valve housing 14.

For relaying the control pressure X_{B} from the activation unit 46 to the assignable control side of the control device 18, which control side is located on the right, there is a media-carrying channel, in particular a fluid-carrying channel 66 whose guide path is apparent especially from FIGS. 1 and 3 and is omitted in FIG. 2 for the sake of simplicity. In particular, an open channel guide is implemented which can be closed by a cover part or other housing parts of the valve housing 14, which is made in several parts as a shut-off part. In the embodiment as shown in FIG. 3, shut-off of the open channel 66 with a cuboidal and flat cover part would be conceivable and as a component of the valve housing 14 and therefore as a shut-off part it can be connected to the remaining valve housing 14 by the cover part being connected to the remaining valve housing 14 by way of a screw connection which is not detailed. In this embodiment as shown in FIG. 1 which essentially relates to a longitudinal section through the valve housing which is otherwise shown as a half, the correspondingly made valve housing side which in this respect constitutes the other half would have to be connected fluid-tight to the illustrated valve housing. This housing part piece which is made complementary to the illustrated housing part piece comparably to FIG. 1 could then have the corresponding guide of the channel which then interacts accordingly with the illustrated channel 66 to carry media.

The guide path of the media channel 66, except for the two media passage sites 68, 70 to the assignable control side of the control device 18 and to the activation unit 46, is separated media-tight, especially fluid-tight relative to the detachable shut-off part (cover part or valve housing part) by means of a sealing device 72 which is not shown in FIG. 1 for the sake of simplicity. The sealing device 72 can be a peripheral lip seal (FIG. 3) of elastomer material or the like which can be inserted, for example, into a peripheral groove which encloses the respectively indicated media channel 66 with the two media passage sites 68, 70, forming a seal. As FIGS. 1 and 3 furthermore show, the guide path of the media channel 66 has a first path section 74 which, viewed in the direction of looking at the figures, is arranged essentially horizontally and parallel to the displacement directions of the spool valves 20, 22. This first center path section towards its respectively free end discharges into two other path sections 76 which have an oblique tilt which runs downward relative to the first path section 74. The, in turn, two free ends of the tilted path sections 76 then each discharge into two end sections 78 as third path sections which in turn run in a horizontal arrangement parallel to the first path section 72. Then the media passage sites 68, 70 each discharge into the pertinent end sections 78. The symmetrically structured media channel 76 has proven especially favorable for laminar flow guidance so that potential power losses in fluid guidance, for example due to turbulence, do not arise.

The valve device according to the invention is used especially preferably for activation of hydraulic fluid; but other applications are also conceivable in which the medium is gaseous, for example, for implementing a pneumatic valve, or relates to other fluids, such as fuel, cooling lubricants, etc. As FIG. 1 furthermore shows, the control or pilot valve 50 on its output side discharges into a fluid-carrying pilot space 80 which discharges into the media passage site 68 via an oblique bore 82 which is only partially shown (FIGS. 1, 3). There is a corresponding oblique channel guide 84 (FIG. 3) for the connection of the media channel 76 by way of its passage site 70 to the rear spring space 40 of the control device 18.

With the indicated fluid guide arrangement, the two pilot valves 48, 50 each control the pertinent face side of the spool valve 20, 22. The control or pilot valve 48, which is the upper one viewed in the direction of looking at FIG. 1, controls the pressure X_{A} in the left-hand pressure chamber on the left end of the spool valve 20; conversely, the lower pilot valve 50 dictates the pressure X_{B} in the activation line to the right face side of the spool valve 22. Due to the valve device arrangement according to the invention, it is not necessary to use an additional differential or actuating piston for activation in order to arrive at the desired valve design with a narrow structure. Instead of using a long, thin drill which is susceptible to failure, to produce the pressure guide in one alternative embodiment, the described media-carrying channel 66 can be provided in a very favorable manner of production by means of a stable cutting tool so that valve scrap rates approach zero in production.

It is surprising to one with average skill in the art that he can arrive at valve designs which are thus kept narrow and which, in spite of the complexity of the valve, allow constructions with a width of less than 40 mm by the illustrated valve construction in which the activation housing 54 with all important components is flanged on the face side to the remaining control housing 12 without any projections with the essential valve components. If it is not critical to keep the size of the valve device very small or narrow, in the solution according to the invention a further mechanical degree of freedom arises by the power-routing channels being able to be made larger; this simplifies appropriately designing the required amounts of fluid for the working ports; in particular, larger fluid volumes can be managed. Due to the lower activation pressure in the groove-like connecting channel design, the wall distance to the pressure-carrying pressure spaces can be chosen to be small so that additional pressure loading of the respective flange surface remains small; this in turn benefits the operating reliability of the valve device as a whole.

1. A hydraulic valve device with a fluid port arrangement (10) which runs at least partially in the valve housing (14), containing ports such as
a pressure supply port (P) for making available a working pressure,
a return port (R),
a section load sensing port (LS),
two control ports (P′_{A} and P′_{B}) and
two useful ports (A, B) for making available a useful port pressure,
and with a movable control device (18) for at least partially activating ports of the fluid port arrangement (10), and the control device (18) can be pressurized with a control pressure (X_{A}, X_{B}) of an assignable activation unit (46) on two opposite control sides, characterized in that for relaying the control pressure (X_{B}) from the activation unit (46) to the assignable control side of the control device (18) a media-carrying channel (66) is used whose guide path runs at least partially as an open channel guide which can be closed off by the cover part or other housing parts of the valve housing (14), which is made in several parts as a shut-off part.

2. The valve device according to claim 1, characterized in that the guide path of the media channel (66), except for the two media passage sites (68, 70) to the assignable control side of the control device (18) and to the activation unit (46), is separated media-tight relative to the detachable shut-off part by means of a sealing device (72).

3. The valve device according to claim 2, characterized in that the guide path of the media channel (66) has a first path section (74) which towards its respectively free end discharges into another path section (76) which has a tilt relative to the first path section (74).

4. The valve device according to claim 3, characterized in that the first path section (74) forms a middle section which is adjacent to the control device (18) and which towards its ends undergoes transition into the other tilted path sections (76) as intermediate sections which in turn with their free ends undergo transition into end sections (78) which are aligned parallel to the direction of the first path section (74).

5. The valve device according to claim 4, characterized in that the end sections (78) with their free ends discharge both in the direction of the activation unit (46) and also in the direction of the assignable control side of the control device (18).

6. The valve device according to claim 1, characterized in that the control device (18) is formed from at least one spool valve (20, 22) which can be moved spring-centered into the initial position.

7. The valve device according to claim 1, characterized in that the activation unit (46) has at least two control valves (48, 50), of which one control valve (48) activates one control side (X_{A}) and the other control valve (50) activates the other control side (X_{B}) of the control device (18).

8. The valve device according to claim 7, characterized in that the respective control valves (48, 50) of the activation unit (46) are arranged combined in one unit jointly on the face side of the remaining valve housing (14).

9. The valve device according to claim 8, characterized in that the port face side of the valve housing (14) for the activation unit (46) viewed in cross section is kept narrow, preferably at most 40 mm wide together with the shut-off part.

10. The valve device according to claim 7, characterized in that the control valves (48, 50) with their actuation direction are arranged parallel to the actuation direction of the control device (18).
